(19) United States
(12) Patent Application Publication
(10) Pub. No.: US 2025/0201497 A1
(43) Pub. Date: Jun. 19, 2025

(54) DOUBLE-DISCONNECT DOUBLE-POLE BIDIRECTIONAL CONTACTOR WITH REVERSED MAGNETIC FIELDS

(71) Applicant: SAFRAN ELECTRICAL & POWER, Blagnac Cedex (FR)

(72) Inventors: Guillaume PRIEUR, Moissy-Cramayel (FR); Cecil BELTAN, Moissy-Cramayel (FR); Arnaud BADAULT, Moissy-Cramayel (FR); Kévin ENOUF, Moissy-Cramayel (FR)

(73) Assignee: SAFRAN ELECTRICAL & POWER, Blagnac Cedex (FR)

(21) Appl. No.: 18/845,757

(22) PCT Filed: Mar. 29, 2023
(86) PCT No.: PCT/FR2023/050448

§ 371 Date: Sep. 10, 2024

(30) Foreign Application Priority Data
Mar. 29, 2022 (FR) FR2202798

(51) Int. Cl. H01H 9/44; H01H 50/54

(52) U.S. Cl. CPC H01H 9/443; H01H 50/54

(57) ABSTRACT

The invention relates to a double-disconnect double-pole bidirectional contactor configured to be mounted on two parallel busbars, comprising, for each pole, an interrupter chamber, in which the following are disposed:
a moving bridge having first and second moving contacts;
a first fixed contact and a second fixed contact;
a pair of magnets, able to generate a magnetic field with a constant direction, so as to generate a magnetic force for moving an arc appearing between the fixed contacts and the moving contacts of the moving bridge passing from a closed state to an open state;
four blocks of fins;
four arc guides.

The two interrupter chambers are configured to simultaneously extinguish arcs having a first current direction for one pole, and arcs having a second current direction for the other pole, the first and second current directions being opposed. The first and second interrupter chambers are disposed parallel and are up against each other, defining a joining zone that is parallel to a direction of movement between the closed state and the open state of each of the two moving bridges, the first and second interrupter chambers being in fluid communication at least partly in the joining zone. There are four magnets and the pairs of magnets of the two poles are disposed so that the magnetic fields generated in the two poles are in a parallel direction but in opposite directions.

### TECHNICAL FIELD

The technical field of the invention is that of contactor chambers.

The invention relates to a double-disconnect double-pole bidirectional contactor that is adapted to be mounted on busbars. A contactor is obtained that is compact and can be used in electrical power distribution, in particular in an aircraft.

### PRIOR ART

A contactor is a remote-controlled electrical switch for establishing or interrupting the passage of an electric current. The contactor may be unipole, bipole, tripole or tetrapole, depending on whether it has one, two, three or four power contacts (poles).

In the context of the invention, the concern is with a double-disconnect bipole or double-pole bidirectional contactor (translation contactor). Such a double-disconnect double-pole bidirectional contactor makes it possible for example to simultaneously disconnect the positive terminal and the negative terminal of an HVDC battery.

As is known and as illustrated in FIG. 1, a double-disconnect bidirectional contactor includes:
a bridge 2 able to move between a closed state and an open state, comprising a first moving contact 20 and a second moving contact 21;
a first fixed contact 30 facing the first moving contact 20, and a second fixed contact 31 facing the second moving contact 21, the first and second moving contact 20, 21 being, in the closed state, in contact with respectively the first and second fixed contact 30, 31, and the first and second moving contact 20, 21 being distant, in the open state, from respectively the first and second fixed contact 30, 31;
a pair of magnets, able to generate a magnetic field B with a constant direction, so as to generate a magnetic force for moving an arc 9 appearing between the fixed contacts and the moving contacts of the moving bridge passing from a closed state to an open state;
an interrupter chamber 1 for extinguishing arcs having a first current direction, said interrupter chamber comprising:
   four blocks of fins 4 each having:
      a first 41 and second end 42;
      fins 43 lying between the first end 41 and the second end 42 of the corresponding block of fins 4;
four arc guides 5, each arc guide being directed from a moving contact of the moving bridge 2 to its respective block of fins 4.

The arc blow in the contactor is a magnetic blow by permanent magnet. This is a tried and tested technique, which is found in HVDC high-voltage direct-current contactors and circuit breakers. It makes it possible to generate a magnetic field which, by coming into interaction with the arc, moves it in accordance with the Laplace force.

The arc guides direct the arcs towards their respective blocks of fins, the blocks of fins serving as an arc extinction device. Each block makes it possible to divide and extinguish an arc directed towards the block.

With reference to FIG. 2, which is an outline diagram of the double electrical contacts of a double-disconnect bidirectional contactor, it can be seen that the contactor includes, firstly, first and second fixed contacts 30, 31 and, secondly, first and second moving contacts 20, 21 on a moving bridge 2. The first moving contact 20 is facing the first fixed contact 30, and the second moving contact 21 is facing the second fixed contact 31. FIG. 2 shows the moving bridge 2 in the open state. When the moving bridge 2 is in the closed state, a current i can move from the first fixed contact 30 to the second fixed contact 31 by passing through the moving bridge 2. The contactor is said to be bidirectional since the electrical circulation of the current can be reversed so that the current moves from the second fixed contact 31 to the first fixed contact 30 by passing through the moving bridge 2, the direction of the physical current being reversed at the contacts 30, 20, 31, 21.

Unlike a single-pole contactor, a double-disconnect double-pole contactor 12 includes two interrupter chambers 1a, 1b.

Furthermore, as it is wished for the integration of the contactor 12 in a distribution box 13 to take place on busbars 15 rather than by cabling (a “busbar” is a term commonly used in the field of electrical distribution”, and is an element affording both a mechanical connection and an electrical connection), the two chambers are disposed parallel and adjacent (up against each other), in order to minimize the space requirement and to facilitate the emergence of fastening lugs 8 for installing the contactor 12 in a distribution box 13. FIG. 3 shows the installation of a double-disconnect double-pole bidirectional contactor 12 in a distribution box 13 with a power busbar 15 and the directions of circulation of the currents i. One pole of the connector can thus be connected, at the outlet of the distribution box, by cabling 16, to the “+” terminal of a battery 14, and the other pole connected to the “−” terminal of the battery 14.

FIG. 4 details a side view of a double-disconnect double-pole bidirectional contactor of the prior art that can be mounted on busbars, the magnetic field B being in the same direction as the two interrupter chambers 1a, 1b; the arcs when the power contacts open can also be seen.

On FIG. 5, the two chambers 1a, 1b of the double-pole bidirectional contactor can be seen in a plan view taken at the cutting plane AA of FIG. 4. As can be seen in this FIG. 5, the two interrupter chambers of the double-pole connector of the prior art are separated by an internal wall 11 common to the two chambers and a single pair 7 of magnets makes it possible to create a magnetic field B in each of the two interrupter chambers, the two fields being oriented in the same direction in the two interrupter chambers 1a, 1b. There is furthermore, in each chamber, another discontinuous internal wall 17, disposed perpendicularly to the internal wall 11, which isolates the adjacent blocks of fins, and has an opening to enable the moving bridge 2 to pass.

Because of this particular configuration, when the double-disconnect double-pole bidirectional contactor of FIG. 5 opens, four electric arcs form, two arcs of which are directed towards the interior of the contactor (internal arcs 9). When the magnetic field is in the same direction in both interrupter chambers, the two arcs that are going inwards face each other. It is therefore necessary for the internal wall 11 separating the two interrupter chambers to be an electrically insulating wall to avoid a short-circuit. And, even with this insulating wall, since the two interrupter chambers are closed but are not hermetic, there exists all the same a risk of the two arcs encountering each other and making only one (the arc path between the two poles is represented by the discontinuous line 6), which would cause a short-circuit directly between the two poles.

Furthermore, the walls located behind the fins create a blockage of the airflow, which may prevent the arc from entering the fins. For the walls located at the periphery of the contactor, this is not a problem since it is possible to create apertures in the walls or absolutely omit them, but it is not possible to remove the wall 11 separating the two chambers because of the risk of short-circuit.

In light of the above, the inventors have sought to design a double-disconnect double-pole bidirectional contactor that is compact, in order to be able to be mounted on busbars, and in which the risks of short-circuit between the arcs are minimized and the circulation of the flows of air is facilitated.

### DESCRIPTION OF THE INVENTION

This aim is achieved by means of a double-disconnect double-pole bidirectional contactor configured to be mounted on busbars (in fact two parallel busbars), comprising, for each pole, an interrupter chamber, in which the following are disposed:
a bridge able to move between a closed state and an open state, comprising a first moving contact and a second moving contact;
a first fixed contact facing the first moving contact, and a second fixed contact facing the second moving contact, the first and second moving contacts being, in the closed state, in contact with respectively the first and second fixed contacts, and the first and second moving contacts being distant, in the open state, from respectively the first and second fixed contacts;
a pair of magnets, able to generate a magnetic field with a constant direction, so as to generate a magnetic force for moving an arc appearing between the fixed contacts and the moving contacts of the moving bridge passing from a closed state to an open state;
four blocks of fins each having:
   a first and second end;
   fins lying between the first end and the second end of the corresponding block of fins;
four arc guides, each arc guide being directed from a moving contact of the moving bridge towards one of the four blocks of fins, each block having its own block of fins;
the two interrupter chambers being configured to simultaneously extinguish arcs having a first current direction for one pole, and arcs having a second current direction for the other pole, the first and second current directions being opposed.

The contactor is characterized in that the first and second interrupter chambers are disposed parallel and up against each other, defining a joining zone, the first and second interrupter chambers being in fluid communication at least partly in the joining zone;
and in that there are four magnets and the pairs of magnets of the two poles are disposed so that the magnetic fields generated in the two poles are in a parallel direction but in opposite directions.

According to the invention, the joining zone is parallel to a direction of movement between the closed state and the open state of each of the two moving bridges.

According to a first variant, the first and second interrupter chambers are separated by an internal wall common to the two chambers, said internal wall being provided with a plurality of through holes. The through holes enable an internal airflow to pass between the two chambers.

According to a second variant, the first and second interrupter chambers are separated only partly by an internal wall, optionally provided with a plurality of through holes.

According to a third variant, no internal wall separates the first and second interrupter chambers.

### BRIEF DESCRIPTION OF THE DRAWINGS

Other aspects, aims, advantages and features of the invention will appear better upon reading the following detailed description of preferred embodiments thereof, given as a non-limiting example, and made with reference to the appended drawings wherein:

FIG. 1 shows, in a side view and in cross-section, an interrupter chamber of a single-pole double-disconnect bidirectional contactor of the prior art;

FIG. 2 is an outline diagram of the double electrical contacts of the double-disconnect bidirectional contactor of FIG. 1;

FIG. 3 is a schematic view of the installation of a double-disconnect double-pole bidirectional contactor in a distribution box with power busbars;

FIG. 4 shows, in a side view and in cross-section, a double-disconnect double-pole bidirectional contactor according to the prior art;

FIG. 5 is a plan view of the double-disconnect double-pole bidirectional contactor of the prior art in a cross-section at the cutting plane AA of FIG. 4;

FIG. 6 is a plan view of an embodiment of the double-disconnect double-pole bidirectional contactor according to the invention;

FIG. 7 is a side view and in cross section of an embodiment of the double-disconnect double-pole bidirectional contactor of the invention;

FIG. 8 is a side view and in cross section of another embodiment of the double-disconnect double-pole bidirectional contactor of the invention (partial internal wall);

FIG. 9 is a side view and in cross section of another embodiment of the double-disconnect double-pole bidirectional contactor of the invention (omission of the internal wall).

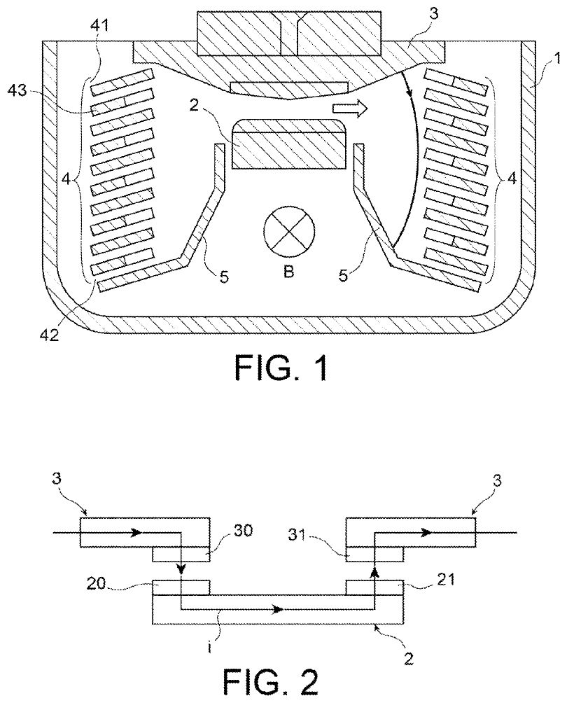

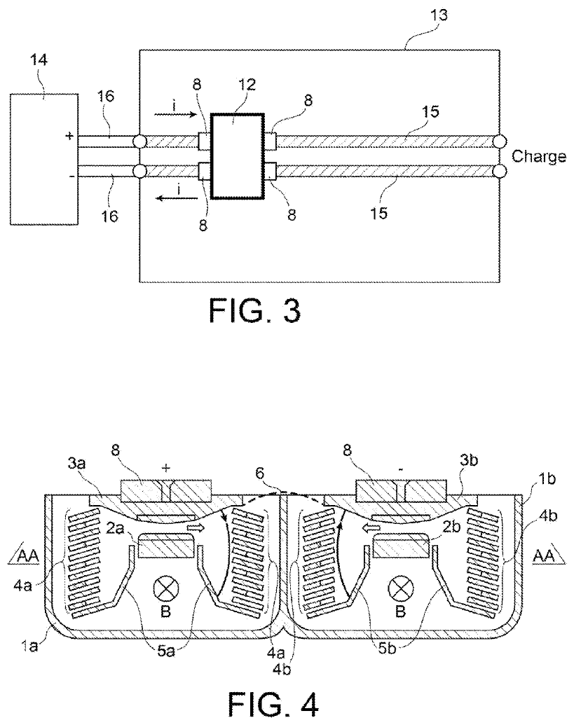

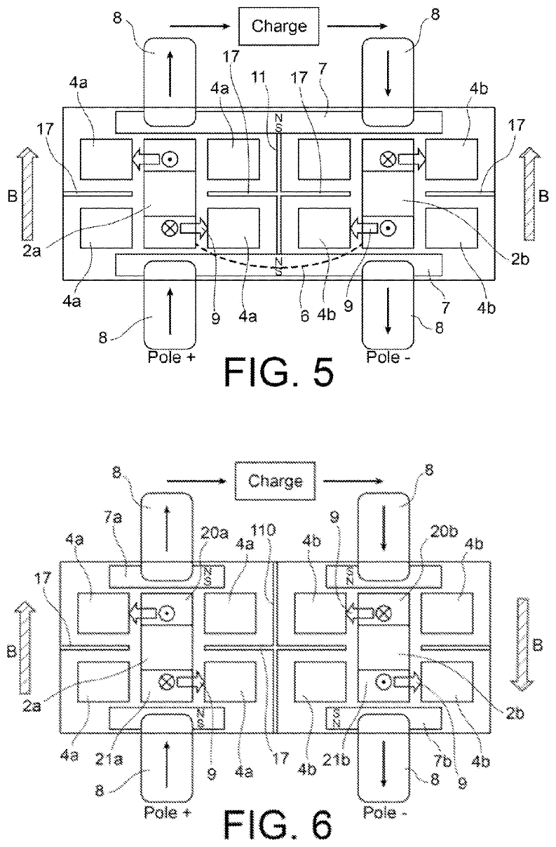

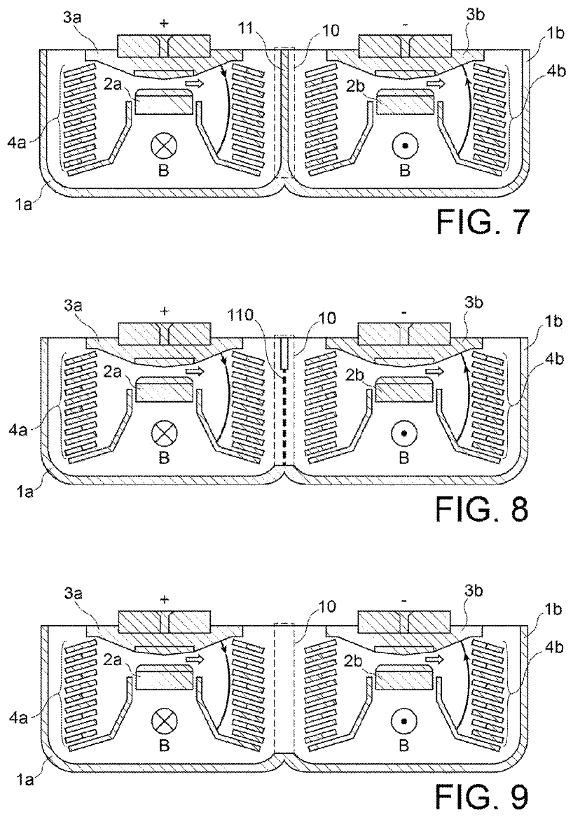

It is stated that, in FIGS. 1, 4, 5, 6, 7, 8, 9, the rectilinear black arrows in a fine line represent the orientation of the current, the large rectilinear arrows represent the orientation of the magnetic field, the medium or small rectilinear arrows without filling represent the orientation of the Laplace force and the direction of movement of the electric arc.

In a known manner, the circles provided with a point or a cross represent respectively a direction going towards, or moving away from, the observer.

### DETAILED DESCRIPTION

The invention consists in configuring the contactor so that the two magnetic fields produced in the two interrupter chambers are parallel, but in opposite directions. This makes it possible to push in the same direction the electric arcs created when the power contacts of the two poles open.

To do this, considering a plane of symmetry separating the two interrupter chambers, a pair of magnets 7a, 7b are placed in each interrupter chamber 1a, 1b and are disposed so that the polarity of a magnet in one pair in a chamber is the opposite to the polarity of the magnet in the other pair disposed symmetrically with respect to the plane of symmetry.

This movement of the arcs in the same direction towards the extinction fins guarantees that there will be no electrical connection between the two poles of the contactor because of attachment of the electric arcs to each other.

This is because, if the magnetic fields in the chambers are in opposite directions, as is the case when two pairs of magnets 7a, 7b disposed as illustrated in FIG. 6 example are used (FIG. 6 showing a plan view of a double-disconnect double-pole bidirectional contactor mountable on a busbar according to one embodiment of the invention, the magnetic fields being opposed in the two interrupter chambers), the internal arcs 9 produced (i.e. those being directed towards the interior of the contactor) are disposed diagonally with respect to each other, and the risk of their joining is therefore reduced.

Thus, by reorganizing the orientation of the internal arcs 9 diagonally by a specific arrangement of the magnets, the internal arcs are not sent towards each other between the two interrupter chambers 1a, 1b, and it is then possible to reduce, or even eliminate, the internal wall separating the two interrupter chambers. This has the effect of not blocking the internal air flows and consequently not preventing the internal arcs from entering their respective blocks of fins.

The two interrupter chambers are disposed parallel and are up against each other, thus defining a joining zone 10. In this joining zone, the internal wall common to the two interrupter chambers can be replaced by a lightened internal wall, or the internal wall can be completely omitted. The two interrupter chambers are thus in fluid communication in this joining zone.

The two interrupter chambers can thus be separated from each other by a partially open internal wall 110 (FIG. 8), such as for example a partition through which their pass a plurality of holes or a filter allowing air to pass. Preferably, the internal wall is made from an electrically insulating material. It may be a case of a wall pierced with a plurality of holes that can be made from a plastics material. However, the internal wall can also be completely omitted (FIG. 9). In this way an optimization of the gaseous exchanges in the contactor is obtained, which favors the quality of extinction of the electric arcs.

In summary, by reversing the magnetic fields between the two chambers, the internal arcs produced when interrupter chambers are used in series do not face each other. This makes it possible to at least partially remove the internal wall that usually separates the two chambers, blocks the air flows and degrades the performances of the contactors. This allows less complicated isolation between the two chambers and a reduction in the risk of short-circuit between the two internal arcs. This also makes it possible to use the useful volume of the second chamber to send the internal arcs produced in the first chamber and vice versa.

1. Double-disconnect double-pole bidirectional contactor configured to be mounted on two parallel busbars, comprising, for each pole, an interrupter chamber, in which the following are disposed:
a bridge able to move between a closed state and an open state, comprising a first moving contact and a second moving contact;
a first fixed contact facing the first moving contact, and a second fixed contact facing the second moving contact, the first and second moving contacts being, in the closed state, in contact with respectively the first and second fixed contacts, and the first and second moving contacts being distant, in the open state, from respectively the first and second fixed contacts;
a pair of magnets, able to generate a magnetic field with a constant direction, so as to generate a magnetic force for moving an arc appearing between the fixed contacts and the moving contacts of the moving bridge passing from a closed state to an open state;
four blocks of fins each having:
a first and second end;
fins lying between the first end and the second end of the corresponding block of fins;
four arc guides, each arc guide being directed from a moving contact of the moving bridge movable to its respective block of fins;
the two interrupter chambers being configured to simultaneously extinguish arcs having a first current direction for one pole, and arcs having a second current direction for the other pole, the first and second current directions being opposed;
wherein the first and second interrupter chambers are disposed parallel and are up against each other, defining a joining zone that is parallel to a direction of movement between the closed state and the open state of each of the two moving bridges, the first and second interrupter chambers being in fluid communication at least partly in the joining zone;
and wherein there are four magnets and the pairs of magnets of the two poles are disposed so that the magnetic fields generated in the two poles are in a parallel direction but in opposite directions.

2. Contactor according to claim 1, wherein the first and second interrupter chambers are separated by an internal wall common to the two chambers, said internal wall 110 being provided with a plurality of through holes.

3. Contactor according to claim 1, wherein the first and second interrupter chambers are separated only partly by an internal wall, optionally provided with a plurality of through holes.

4. Contactor according to claim 1, wherein no internal wall separates the first and second interrupter chambers.
